(19) United States
(12) Patent Application Publication
(10) Pub. No.: US 2009/0008217 A1
(43) Pub. Date: Jan. 8, 2009

(54) POSITIVE LINEAR HANDRAIL DRIVE WITH TOOTHED BELT

(75) Inventors: Changsheng Guo, South Windsor, CT (US); John M. Milton-Benoit, Springfield, MA (US); Bryan R. Siewert, Westbrook, CT (US); Detlev Lindemeier, Wien (AT); Klaus Seehausen, Niedernwohren (DE); Bernward Engelke, Wien (AT)

Correspondence Address: CARLSON GASKEY & OLDS, 400 W MAPLE STE 350, BIRMINGHAM, MI, 48009, US

(73) Assignee: OTIS ELEVATOR COMPANY, Farmington, CT (US)

(21) Appl. No.: 11/912,176

(22) PCT Filed: Aug. 12, 2005
(86) PCT No.: PCT/US05/28944

§ 371 Date: Oct. 22, 2007

Related U.S. Application Data
(60) Provisional application No. 60/678,128, filed on May 5, 2005.

(51) Int. Cl. B66B 23/24

(52) U.S. Cl. 198/337

(57) ABSTRACT

A passenger conveyor handrail (30) is driven by a device (40) including a toothed drive belt (42). An example drive belt has a plurality of teeth (46) with an at least partially concave surface (50) for engaging teeth (36) on the handrail (30). A disclosed example also includes at least partially convex projections (52) near an end of each tooth on the drive belt (42). A driven surface (48) of the drive belt (42) includes a plurality of grooves (70) arranged to allow the drive belt to slip relative to a drive wheel (60) under certain loading conditions. The disclosed example arrangement facilitates proper engagement between a drive belt (42) and a toothed handrail (30) while avoiding vertical separation forces between them, which allows for eliminating pinching rollers that would otherwise engage a gripping surface (32) on the handrail (30).

### 1. FIELD OF THE INVENTION

This invention generally relates to passenger conveyors. More particularly, this invention relates to a device for driving a handrail of a passenger conveyor.

### 2. DESCRIPTION OF THE RELATED ART

Passenger conveyors have proven effective for carrying people between different levels within a building or across an elongated pathway, for example. Typical arrangements include a plurality of steps or a belt upon which an individual stands to be carried from one location to another. A handrail typically rides over a balustrade and provides a surface for an individual to grab onto for stabilizing themself. Typical handrail configurations have a generally flat surface oriented parallel to the ground or the direction of movement of the conveyor (i.e., on an angle relative to vertical along the rise of an escalator).

Handrails are driven to move in unison with the steps or moving belt. A handrail drive mechanism causes the desired movement of the handrail. There are various shortcomings and drawbacks with conventional handrail drive systems. Typical arrangements rely upon pinching rollers that engage oppositely facing sides of the handrail to generate enough friction to drive the handrail in the desired direction.

One problem with conventional driving arrangements is that the pinching rollers engage the gripping surface side of the handrail. This tends to scratch and cause wear in the gripping surface. This results in eventual replacement of a handrail at a time that is earlier than desired. It would be useful to be able to extend the life of a handrail.

Another shortcoming of conventional arrangements is that there is a “friction contradiction” introduced by the need to generate enough friction to move the handrail and a need to allow the handrail to readily slide along a guidance to follow the balustrade. The same surface that needs to be able to easily slide along the guidance is typically engaged by the driving mechanism, which uses friction to engage that surface and propel the handrail.

Additionally, the friction caused by the pinching rollers in the drive mechanism tends to wear the fabric layer used for sliding the handrail along the balustrade. As this fabric layer becomes worn, the handrail eventually cannot operate as desired and requires repair or replacement. At the same time, the presence of the lower friction material requires higher pinching forces on the handrail, which tends to more rapidly cause wear on the gripping surface, which introduces earlier replacement.

A variety of alternative arrangements have been proposed. One early example toothed belt is shown in U.S. Pat. No. 3,749,224, which is used for driving a handrail. The Japanese patent publication 2735453 shows another toothed belt for engaging a correspondingly toothed surface on a handrail. One shortcoming of the arrangement shown in that document is that there is a tendency for vertical separation forces to interfere with desired engagement between the driving belt and the handrail. One example embodiment in that document includes rollers to counteract these vertical separation forces. The presence of rollers against the gripping surface still introduces possible wear on the gripping surface. Alternative driving arrangements are shown in the published applications WO 03/066500 and WO 2004/035451. Other arrangements including a drive belt for moving a handrail are shown in U.S. Pat. Nos. 5,117,960 and 5,307,920.

Despite the publication of these various alternatives, the majority of passenger conveyor installations include the traditional pinching roller drive arrangement. There is a need for an improved handrail drive that avoids the friction contradiction mentioned above, avoids introducing undesirable wear on a gripping surface and maintains sufficient engagement between the handrail and the drive mechanism, which is not compromised by vertical separation forces introduced between a drive belt and a handrail, for example.

This invention addresses those needs.

### SUMMARY OF THE INVENTION

A disclosed exemplary embodiment of this invention provides a positive linear drive for a passenger conveyor handrail including a toothed belt for engaging the handrail that is configured to avoid vertical separation forces between the belt and the handrail.

An exemplary disclosed device for driving a handrail of a passenger conveyor includes a belt having a driving surface including a plurality of teeth that are at least partially concave and adapted to engage a corresponding toothed surface on the handrail.

The belt also has a driven surface that faces in an opposite direction from the driving surface. In one example, the driven surface is generally smooth and continuous in a direction corresponding to a direction of movement provided by the driving surface. In one example, the driven surface includes a plurality of grooves extending along the length of the driven surface in a direction of movement provided by the driving surface. The grooves cooperate with a driving wheel in one example to provide a propelling force to the handrail under a first load and to allow the belt and handrail to slip relative to the drive wheel under relatively higher loaded conditions. Such an arrangement provides the advantage of not requiring a clutch for the handrail drive, for example.

One example passenger conveyor handrail assembly includes a handrail having a gripping surface facing at least partially in a first direction and a driven surface facing in a second, opposite direction. The handrail driven surface in this example has a plurality of teeth. A drive belt has a driving surface comprising a plurality of teeth for engaging the handrail driven surface teeth. Each of the drive belt teeth has at least one of a partially concave surface or a partially convex projection near an end of the tooth that is closest to the handrail gripping surface.

In one example, the teeth on the handrail driven surface have a face for engaging the corresponding driving surface tooth of the belt. The face on each handrail driven surface tooth is generally perpendicular to the direction along which the handrail is driven. In one example, the face on each handrail driven surface tooth is aligned at an angle of approximately 88° relative to the direction of movement.

The various features and advantages of this invention will become apparent to those skilled in the art from the following description of a currently preferred embodiment. The drawings that accompany the detailed description can be briefly described as follows.

### BRIEF DESCRIPTION OF THE DRAWINGS

FIG. 1 schematically shows selected portions of an example passenger conveyor including a handrail driving device designed according to an embodiment of this invention.

FIG. 2 schematically shows selected portions of an example drive belt and an example handrail.

FIG. 3 schematically shows an example configuration of a portion of a drive belt and a cooperating drive wheel.

### DETAILED DESCRIPTION

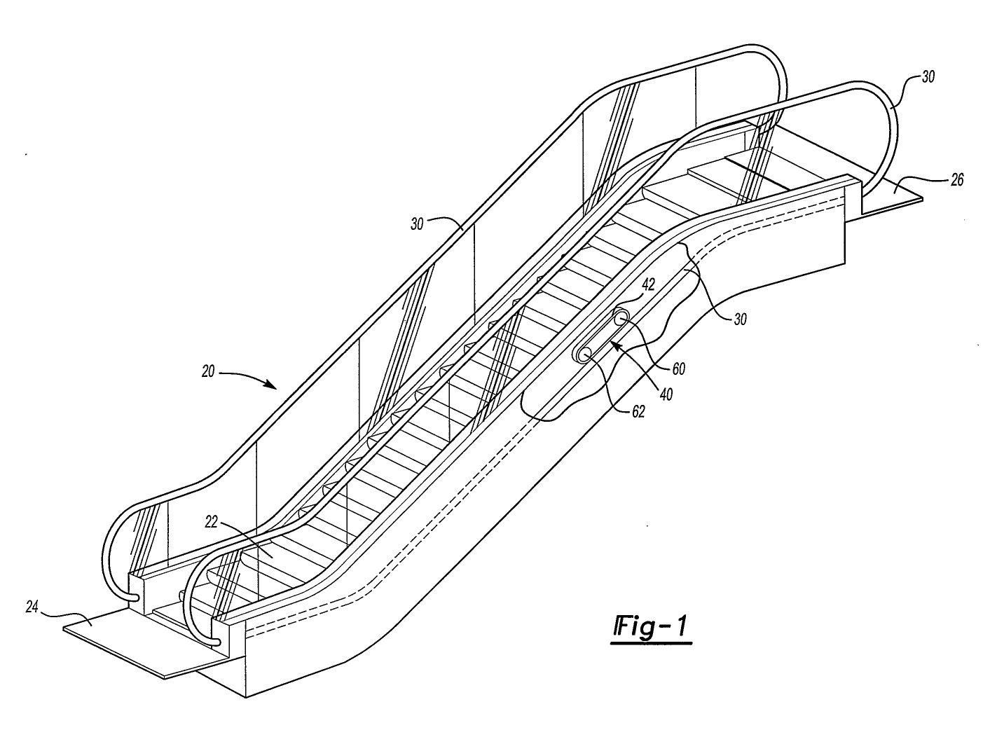

FIG. 1 schematically shows a passenger conveyor 20. In this example, the passenger conveyor is an escalator having a plurality of steps 22 for carrying passengers between landings 24 and 26 at different levels within a building. This invention is not limited to escalators but is also applicable to other forms of passenger conveyors such as moving walkways, for example.

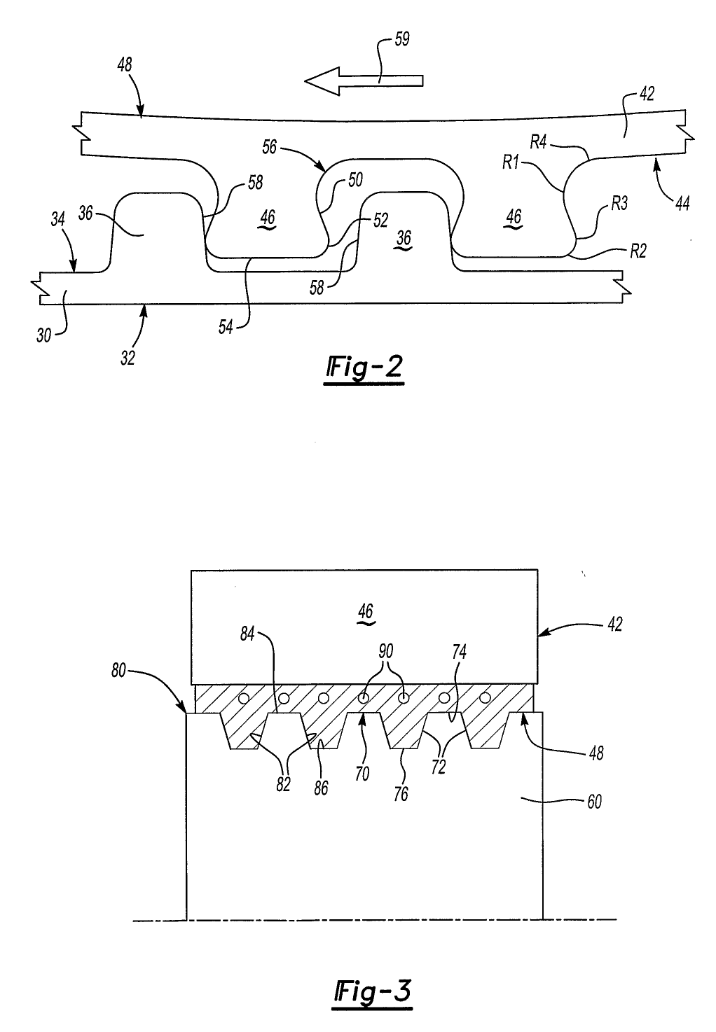

The example passenger conveyor of FIG. 1 includes a handrail 30 that moves along with the steps 22 that can be grasped by a passenger on the conveyor to stabilize themself, for example. FIG. 2 schematically shows one example handrail 30 having a gripping surface 32 facing generally upward in the view of FIG. 1. In the view of FIG. 2, which corresponds to the broken away portion of FIG. 1, the gripping surface 32 faces downward because the handrail is following along the so-called return portion of the handrail loop.

The handrail 30 also includes a driven surface 34 having a plurality of teeth 36. A handrail drive device 40 shown in FIG. 1 includes a drive belt 42 having a driving surface 44 including a plurality of teeth 46 that cooperate with the teeth 36 on the handrail 30 to propel the handrail in a desired direction. In this sense, the illustrated arrangement is a linear positive drive arrangement.

The teeth 46 in the illustrated example have a unique configuration that facilitates proper engagement between the drive belt teeth 46 and the handrail teeth 36. Each tooth 46 includes a generally concave portion 50 along an engaging surface that contacts or engages a corresponding surface on the handrail teeth 36. The example teeth 46 include generally convex projections 52 near an end 54 of each tooth 46, which is distal from a base portion 56.

The example tooth configuration including at least the concave portion 50 facilitates better engagement between the drive belt teeth 46 and the handrail teeth 36. The concave portion 50 along at least a portion of the engaging surface minimizes or eliminates vertical separation forces that otherwise tend to cause the handrail teeth 36 to move away from the drive belt 42 when the handrail 30 is being driven. The projections 52 also facilitate minimizing or eliminating vertical separation forces because they provide an at least slightly deformable leading edge to distribute forces associated with engagement between the teeth 46 and the teeth 36. This further enhances the ability for the example arrangement to avoid vertical separation forces.

As schematically shown in FIG. 2, the teeth 46 include a plurality of radii of curvature along the engaging faces of the teeth. A first radius R₁ in this example is larger than a second radius R₂ along a portion of the projection 52. In one example, the radius R₁ is between about ½ and about ⅗ a distance between the base portion 56 and the end surface 54 (i.e., a height) of each tooth 46. In one example, the radius R₂ is between about ⅖ and about ½ the distance between the base portion 56 and the end surface 54.

The illustrated example includes another radius R₃, which comprises a transition between the concave portion 50 and the projection 52. In one example, the radius R₃ is between about ⅓ and about ½ the size of the radius R₂. The illustrated example includes another radius R₄ at a transition between the concave portion 50 and the base portion 56. In this example, the radius R₄ is between about ¼ and about ⅓ the size of the radius R₁.

In one particular embodiment, the distance between the base portion 56 and the end surface 54 on each tooth 46 is approximately five millimeters. The radius R₁ is approximately 2.8 millimeters. The radius R₂ is approximately 0.8 millimeters. The radius R₃ is approximately 2.1 millimeters. The radius R₄ is approximately 0.9 millimeters. These dimensions are useful in an example where the entire belt 42 is approximately 1.5 meters long.

In one example, the various radii of curvature are selected to provide a large enough radius along the projection 52 and along the concave portion 50 to avoid clashing between the drive belt teeth 46 and the handrail teeth 36. In one example, the handrail 30 and the drive belt 42 both comprise a thermoplastic polyurethane material and the illustrated geometric configuration avoids clashing between the teeth associated with engagement between them.

The example teeth are also arranged to have cooperating pitches that avoid clashing. For example, a spacing between the teeth 36 (i.e., a pitch of the handrail teeth) and the size of the teeth 36 is arranged so that the teeth 36 fit within clearances between the drive belt teeth 46 as can be appreciated from FIG. 2, for example. In other words, a spacing between the projection 52 on one tooth 46 and an oppositely facing projection 52 on an adjacent tooth 46 is greater than a width of each tooth 36 on the handrail 30.

In one example, the surfaces on the teeth 36 that directly contact a surface on the teeth 46 are oriented at an angle that is slightly less than perpendicular to a direction of movement of the handrail caused by the drive belt 42. In the example of FIG. 2, a surface 58 on each side of each tooth 36 is at an angle of approximately 88° relative to a direction of movement shown schematically by the arrow 59. Keeping these surfaces 58 on the teeth 36 near a vertical orientation but not directly perpendicular to the direction of movement further facilitates avoiding vertical separation forces between the drive belt 42 and the handrail 30.

Another feature of the example arrangement is shown schematically in FIGS. 1 and 3. At least one drive wheel 60 and a follower wheel 62 establish a loop about which the drive belt 42 travels responsive to movement of the drive wheel 60. As best appreciated from FIG. 3, the driven surface 48 of the drive belt 42 includes a plurality of grooves 70. In the illustrated example, side surfaces 72 on each groove 70 are at oblique angles relative to each other. Each groove 70 has a depth defined by a distance between a base surface 74 and an outermost surface 76 on the driven surface 48.

In this example, the drive wheel 60 has an exterior circumferential configuration 80 that is complementary to the grooved configuration of the driven surface 48 of the belt 42. In this example, the drive wheel exterior configuration 80 includes a plurality of grooves having side surfaces 82 angled complimentary to the angles of the side surfaces 72 of the belt grooves 70. The grooves on the drive wheel 60 have a depth between an outermost surface 84 and a base surface 86 that corresponds to the depth of the grooves 70 on the belt 42 in this example.

One advantage to the disclosed example is that the grooves run generally parallel to the direction in which the drive belt 42 propels the handrail 30. Such an arrangement allows for generating enough force to drive the handrail 30 under a normal loaded condition. Under undesirably heavy loads, the arrangement of the grooves 70 and the cooperating surface 80 on the wheel 60 allow the belt 42 to slip relative to the wheel 60. Such an arrangement avoids the need for a clutch on the driving mechanism for moving the drive wheel 60.

Another feature of the example embodiment is that a plurality of reinforcing members such as steel or polymer cords 90 are within the body of the drive belt 42.

One example includes using different materials for the teeth 46 and the grooves 70. A first portion of such an example includes a polyurethane material for forming the teeth 46 having a shore hardness in the range from 90 A to 92 A. The driven surface portion 48 in the same example has a shore hardness of about 88 A and is also made from a polyurethane material. Providing a slightly softer material for the driven surface 48 provides better friction characteristics between the drive wheel 60 and the belt 42. Using a harder material for the teeth 46 provides better driving characteristics and avoids vertical separation forces as discussed above. Given this description, those skilled in the art will be able to select appropriate materials or combinations of materials to meet the needs of their particular situation.

The disclosed example provides the significant advantage of minimizing vertical separation forces so that no supporting rollers need to engage the gripping surface 32 on the handrail 30 while still having a reliable driving interaction between the drive belt 42 and the handrail 30.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for driving a handrail of a passenger conveyor, comprising:
a belt having a driving surface including a plurality of teeth that are at least partially concave and adapted to engage a corresponding toothed surface on the handrail.

2. The device of claim 1, wherein the belt includes a driven surface that faces in an opposite direction from the driving surface and the driven surface is generally smooth and continuous in a direction corresponding to a direction of movement provided by the driving surface.

3. The device of claim 2, wherein the driven surface includes a plurality of grooves extending along a length of the driven surface in a direction of movement provided by the driving surface.

4. The device of claim 3, wherein the grooves have side surfaces at oblique angles relative to each other.

5. The device of claim 3, comprising a drive wheel having a grooved exterior surface corresponding to the grooves on the driven surface of the belt.

6. The device of claim 5, comprising a second wheel spaced from the drive wheel such that the belt follows a loop around the wheels and wherein the grooves on the driven surface of the belt and the grooved exterior surface of the drive wheel cooperate for propelling the belt around the loop under a first load and for allowing the belt to slip relative to the drive wheel under a second, greater load.

7. The device of claim 2, wherein at least the driving surface of the belt comprises a first material and at least the driven surface comprises a second, different material.

8. The device of claim 7, wherein the first material is harder than the second material.

9. The device of claim 7, wherein the first and second materials each comprise a polyurethane.

10. The device of claim 1, wherein the driving surface teeth each comprise a base and an at least partially convex projection near an end distal from the base.

11. The device of claim 1, wherein the driving surface teeth each comprise a base and a generally convex projection near an end distal from the base and wherein each tooth has a first radius of curvature along a concave portion near the base and a second, smaller radius of curvature along the projection.

12. The device of claim 11, wherein each tooth has a height extending between the base and the end and wherein the first radius is between about ½ and about ⅗ the height and wherein the second radius is between about ⅖ and about ½ the height.

13. The device of claim 12, comprising a third radius of curvature between the second radius of curvature and the end, the third radius of curvature is between about ⅓ and about ½ the second radius and comprising a fourth radius of curvature between the first radius of curvature and the base, the fourth radius is between about ¼ and about ⅓ the first radius.

14. A passenger conveyor handrail assembly, comprising:
a handrail having a gripping surface facing at least partially in a first direction and a driven surface facing in a second, opposite direction, the handrail driven surface having a plurality of teeth; and
a drive belt having a driving surface comprising a plurality of teeth for engaging the handrail driven surface teeth, each of the driving surface teeth having at least one of a partially concave surface or an at least partially convex projection near an end that is closest to the handrail gripping surface.

15. The assembly of claim 14, wherein the driving surface teeth propel the handrail driven surface teeth along a direction and wherein the handrail driven surface teeth each have a face for engaging a corresponding driving surface tooth and wherein the face is generally perpendicular to the direction.

16. The assembly of claim 15, wherein the face is aligned at approximately 88 degrees relative to the direction.

17. The assembly of claim 14, including a spacing between the driving surface teeth that is greater than a length of the handrail driven surface teeth along a direction that the belt propels the handrail.

18. The assembly of claim 14, including a drive wheel for driving the belt and having a plurality of grooves extending circumferentially around the drive wheel and wherein the belt has a driven surface with a corresponding plurality of grooves extending along a direction that the belt propels the handrail.

19. The assembly of claim 14, including a drive wheel for driving the belt and wherein the belt has a first portion including the teeth of the driving surface and a second portion including a driven surface that cooperates with the drive wheel and wherein the first portion of the belt comprises a first material and the second portion comprises a second, softer material.

20. The assembly of claim 14, wherein the teeth on the handrail driven surface and the teeth on the belt driving surface comprise polyurethane.
